(19) United States
(12) Patent Application Publication
(10) Pub. No.: US 2014/0156270 A1
(43) Pub. Date: Jun. 5, 2014

(54) APPARATUS AND METHOD FOR SPEECH RECOGNITION

(71) Applicants: HYUNDAI MOTOR COMPANY, Seoul (KR); HALLA CLIMATE CONTROL CORPORATION, Daejeon (KR)

(72) Inventors: Gee Young Shin, Suwon (KR); Jeong Hoon Lee, Daejeon (KR)

(73) Assignees: Halla Climate Control Corporation, Daejeon (KR); Hyundai Motor Company, Seoul (KR)

(21) Appl. No.: 13/846,387

(22) Filed: Mar. 18, 2013

(30) Foreign Application Priority Data
Dec. 5, 2012 (KR) 10-2012-0140240

(51) Int. Cl. G10L 15/22

(52) U.S. Cl. CPC G10L 15/22
USPC 704/231

(57) ABSTRACT

Disclosed herein is an apparatus and a method for speech recognition. The apparatus includes a controller that is configured to receive a speech signal including a speech recognition waveform from a user and the waveform of speech generated within a vehicle, when a speech recognition operation initiates. The controller is further configured to generate an offset waveform corresponding to a speech output waveform generated from a speech output device within the vehicle, using feature information of the speech output waveform, when the speech recognition operation initiates. Additionally, the controller is configured to extract the speech recognition waveform of the user by removing a predetermined amount or more of the speech output waveform from a speech signal input by overlapping the offset waveform to the speech signal and to perform speech recognition based on the speech recognition waveform.

### CROSS-REFERENCE TO RELATED APPLICATION

This application is based on and claims priority from Korean Patent Application No. 10-2012-0140240, filed on Dec. 5, 2012 in the Korean Intellectual Property Office, the disclosure of which is incorporated herein in its entirety by reference.

### BACKGROUND OF THE INVENTION

1. Field of the Invention

The present invention relates to an apparatus and a method for speech recognition to improve the rate of speech recognition by offsetting voice output waveforms.

2. Description of the Prior Art

Recently, vehicles are being equipped with a speech recognition technology to perform some of the available vehicles functions by recognizing speech. However, when speech recognition is performed while a vehicle travels, audio output and speech guide, such as, path guide of a navigation device are also performed, so the rate of speech recognition may decrease. Further, noise due to wind generated by an air conditioning system may be input to an apparatus for speech recognition together with speech of a user in speech recognition, thereby causing disruption in the speech recognition and reducing the rate of speech recognition. Therefore, he volume of an audio system or a navigation device must be reduced to increase the rate of speech recognition while a vehicle travels, thereby requiring additional operations to be performed prior to speech recognition.

### SUMMARY

Accordingly, the present invention provides an apparatus and a method for speech recognition which increase a rate of speech recognition by offsetting voice output waveforms output from the speech output apparatus in speech recognition. Additionally, the present invention provides an apparatus and a method for removing speech output waveforms from speech signals by generating speech output offset waveforms through modulation of frequency features of speech output waveforms. In addition, the apparatus and the method for speech recognition may increase a rate of speech recognition by adjusting the air output from an air conditioning system that operates during speech recognition.

In one aspect of the present invention, an apparatus for speech recognition includes: a speech input unit configured to receive a speech signal including a speech recognition waveform of a user and the waveform of speech generated within the vehicle, when a speech recognition operation starts; an offset waveform generating unit configured to generate an offset waveform corresponding to a speech output waveform generated from a speech output device within the vehicle, using feature information of the speech output waveform, when the speech recognition operation starts; a speech recognition waveform extracting unit configured to extract the speech recognition waveform from the user by removing a predetermined amount or more of the speech output waveform from a speech signal input through the speech input unit, by overlapping the offset waveform to the speech signal; and a speech recognizing unit configured to perform speech recognition based on the speech recognition waveform.

The offset waveform generating unit may be configured to generate an offset waveform corresponding to the speech output waveform based on the feature information of the speech output device generating the speech output waveform. Furthermore, the offset waveform generating unit may be configured to generate an offset waveform corresponding to the speech output waveform by modulating the amplitude and the phase of the original signal based on the frequency feature of the speech output waveform. The offset waveform may be a signal with the phase modulated by 180° from the speech output waveform.

The speech recognition waveform extracting unit or the speech recognizing unit may be configured to adjust the air volume from an air conditioning system by transmitting a signal showing the start of a speech recognition operation to an air conditioning system in a vehicle based on the waveforms in a speech signal, when the speech signal is input.

In another aspect of the present invention, a method for speech recognition includes: receiving, by a controller, a speech signal including a speech recognition waveform of a user and the waveform of speech generated within the vehicle, when a speech recognition operation starts; generating, by the controller, an offset waveform corresponding to a speech output waveform generated from a speech output device within the vehicle, using feature information of the speech output waveform, when the speech recognition operation starts; extracting, by the controller, the speech recognition waveform from the user by removing a predetermined amount or more of the speech output waveform from a speech signal input through the speech input unit, by overlapping the offset waveform to the speech signal; and performing, by the controller, speech recognition based on the speech recognition waveform.

The generating of the offset waveform may include generating, by the controller, an offset waveform corresponding to the speech output waveform based on the feature information of the speech output device generating the speech output waveform. Additionally, the generating of the offset waveform may include generating, by the controller, an offset waveform corresponding to the speech output waveform by modulating the amplitude and the phase of the original signal based on the frequency feature of the speech output waveform. The offset waveform may be a signal with the phase modulated by 180° from the speech output waveform.

The method may further include adjusting, by the controller, the air volume from an air conditioning system by transmitting a signal showing the start of a speech recognition operation to an air conditioning controller in a vehicle, when the speech recognition operation starts.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram illustrating the configuration of an apparatus for speech recognition according to an exemplary embodiment of the present invention;

FIG. 2 is an exemplary diagram illustrating offsetting speech output signal of an apparatus for speech recognition according to an exemplary embodiment of the present invention;

FIG. 3 is an exemplary block diagram illustrating the configuration of an apparatus for speech recognition according to another exemplary embodiment of the present invention;

FIG. 4 is an exemplary flowchart illustrating the flow of operation of a method for speech recognition according to an exemplary embodiment of the present invention; and

FIG. 5 is an exemplary flowchart illustrating the flow of operation of a method for speech recognition according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described with reference to the accompanying drawings.

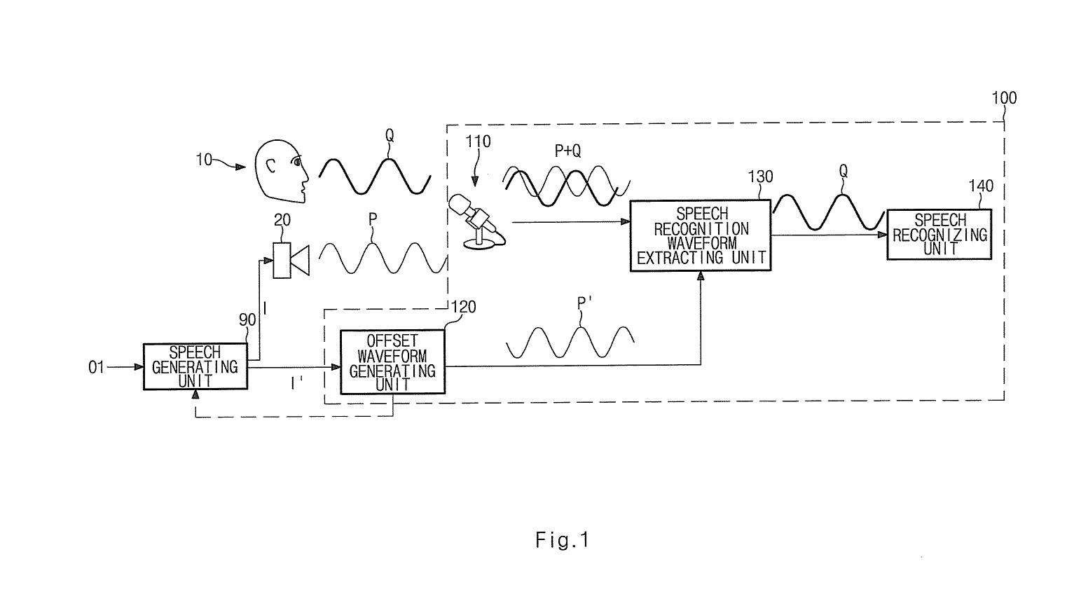

FIG. 1 is an exemplary block diagram illustrating the configuration of an apparatus for speech recognition according to an exemplary embodiment of the present invention. Referring to FIG. 1, an apparatus 100 for speech recognition according to an exemplary embodiment of the present invention may include a plurality of units operated by a controller. The plurality of units may include a speech input unit 110, an offset waveform generating unit 120, a speech recognition waveform extracting unit 130, and a speech recognizing unit 140.

The speech input unit 110 may be configured to receive speech signals such as from a microphone. The speech input unit 110 may be configured to receive speech signals generated within the vehicle by operating when a speech recognition operation initiates Speech signals input through the speech input unit 110 may be input with a speech output waveform P generated by a speech output device 20 such as a speaker, other than a speech recognition waveform Q from a user 10, in other words, a user's voice. The speech input unit 110 may be configured to transmit the input speech signal (P+Q) to the speech recognition waveform extracting unit 130.

When a speech recognition operation initiates, the offset waveform generating unit 120 may be configured to receive feature information I′ of an electric signal I transmitted to the speech output device 20 from a speech generating unit 90 which may be configured to generate the electric signal I for outputting speech to the speech output device 20. Furthermore, the offset waveform generating unit 120 may be configured to receive an electric signal generated from the speech generating unit 90 and unique feature information of the speech output device 20, before the speech recognition operation initiates. The offset waveform generating unit 120 may be configured to send a signal 01 that requests feature information on a speech output signal to the speech generating unit 90, when the speech recognition operation initiates.

The speech generating unit 90, may be configured to generate an electric signal for speech output. The speech generating unit 90 may be operated by a speech guide controller or a multimedia controller and may be further configured to transmit an electric signal I for outputting speech to the speech output device 20 to generate, by the speech output device 20, a corresponding speech output waveform P.

The offset waveform generating unit 120 may be configured to generate an offset waveform P′ to the speech output waveform P based on the signal or feature information I′ of the apparatus sent from the speech generating unit 90. The offset waveform generating unit 120 may be configured to generate the offset waveform P′ by modulating the frequency, that is, the amplitude and phase of the speech output waveform P.

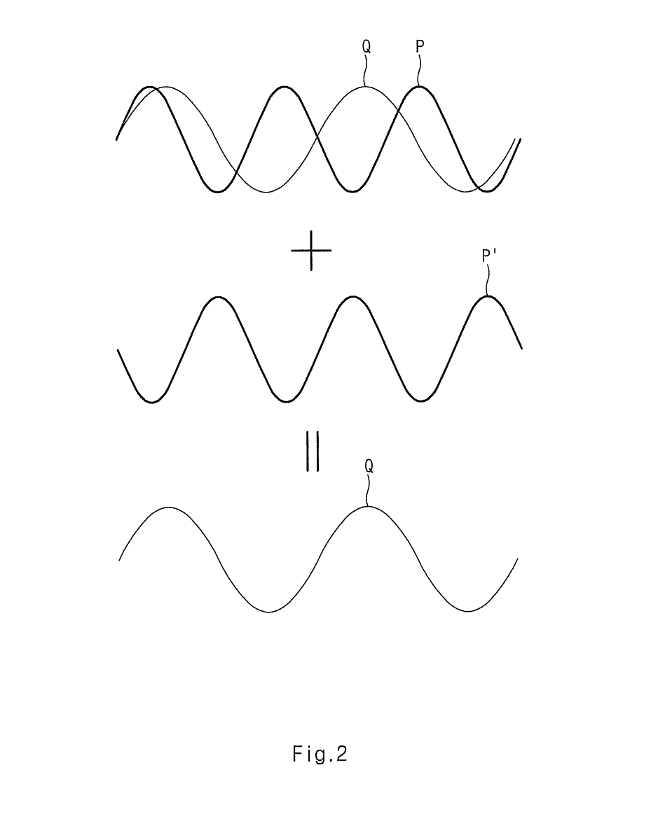

The speech recognition waveform extracting unit 130 may be configured to overlap the offset waveform P′ generated by the offset waveform generating unit 120 to the speech signal P+Q input through the speech input unit 110. In particular, the speech output waveform P in the speech signal P+Q may be offset by the offset waveform P′. Therefore, the speech recognition waveform extracting unit 130 may be configured to extract the speech recognition waveform Q with removal of the speech output waveform P. The operation of extracting a speech recognition waveform will be described in more detail with reference to FIG. 2.

The speech recognition waveform extracting unit 130 may be configured to send the extracted speech recognition waveform Q to the speech recognizing unit 140. As another example, when a speech signal is input, the speech recognition waveform extracting unit 130 or the speech recognizing unit 140 may be configured to output a signal 01 for requesting feature information of the speech output signal to the speech generating unit 90 based on whether an offset waveform is generated or the waveforms are overlapped to the input speech signal. The speech generating unit 90 may be configured to send a speech output signal and feature information of the speech output device 20 to the offset waveform generating unit 120 in response to the signal 01 for requesting feature information of the speech output signal. Moreover, the unit configured to output the signal 01 for requesting feature information of the speech output signal to the speech generating unit 90 may be varied in any way in accordance with the exemplary embodiment.

The speech recognizing unit 140 may be configured to perform speech recognition by analyzing the speech recognition waveform Q sent from the speech recognition waveform extracting unit 130. Since a predetermined amount or more of speech output waveform P may be removed from the speech recognition waveform Q sent to the speech recognizing unit 140, a rate of speech recognition may increase. Furthermore, the speech generating unit 90 may be configured to output a guide speech signal according to the result of recognizing speech from the speech recognizing unit 140 to the speech to output device 20.

FIG. 2 is an exemplary diagram illustrating offsetting speech output signal of an apparatus for speech recognition according to an exemplary embodiment of the present invention. Referring to FIG. 2, a speech signal input to the apparatus for speech recognition may be a signal with a speech recognition signal and noise signals within the vehicle which overlap. For example, the speech signal is a signal when the speech recognition waveform Q for voice from the user 10 and a speech output signal P output from a speaker overlap. Moreover, the speech signal may further include other noise signals within the vehicle. However, in the exemplary embodiment of the present invention the speech signal includes a speech recognition waveform and a speech output waveform in the description of an exemplary embodiment of the present invention.

The apparatus for speech recognition may be configured to generate an offset waveform for offsetting the speech output waveform from the speech signal. The offset waveform may be a signal with the amplitude and the phase modulated based on the frequency feature of the speech output waveform. In particular, the offset waveform P′ may be used to offset a predetermined or more amount of speech output waveform P, thus the phase difference from the speech output waveform P may be 180°.

As described above, the offset waveform P′ may have a phase difference of about 180° from the speech output waveform P, when the speech signal and the offset waveform are overlapped, the speech output waveform may be substantially removed from the speech signal to retain only the speech recognition waveform.

Moreover, although the speech output waveform may not be completely removed from the speech signal based on an error, a predetermined amount or more of speech output waveform may be assumed to be removed. Furthermore, when offset waveforms fail to completely remove the speech output waveform, the apparatus for speech recognition may be configured to generate an offset waveform substantially similar to a waveform symmetric in parallel to the speech output waveform by adjusting the offset waveform generation conditions.

The speech recognition waveform extracting unit 130 may be configured to overlap the offset waveform P′ generated by the offset waveform generating unit 120 to the speech signal P+Q input through the speech input unit 110. In particular, the speech output waveform in the speech signal may be offset by the offset waveform. Therefore, the speech recognition waveform extracting unit 130 may be configured to extract the speech recognition waveform with removal of the speech output waveform from the speech signal.

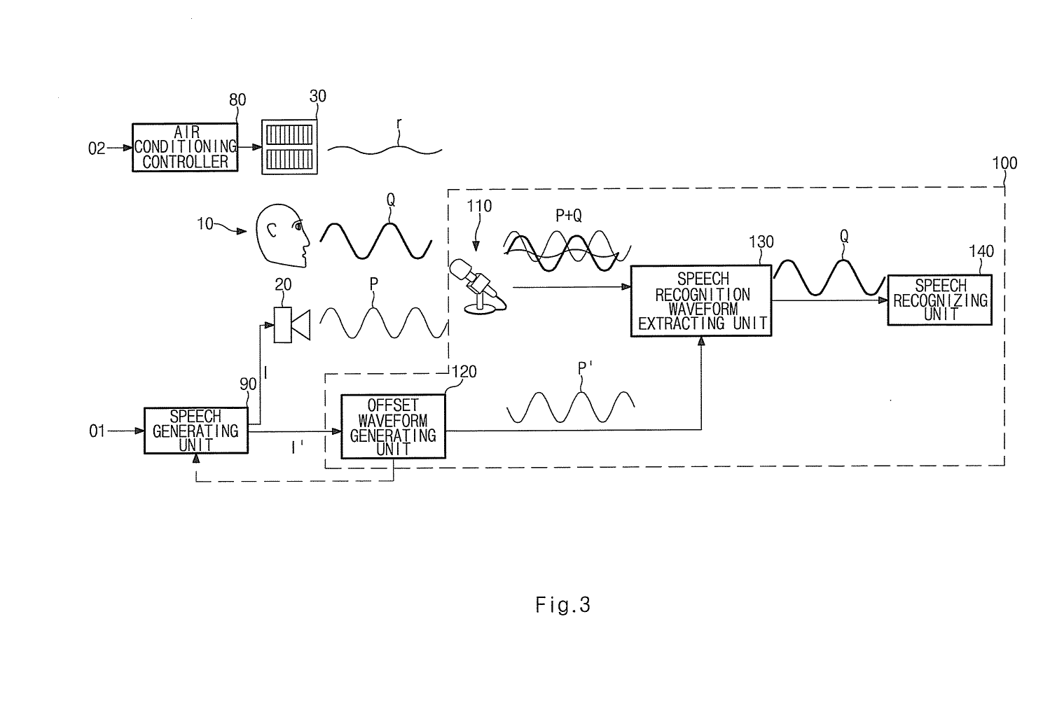

FIG. 3 is an exemplary diagram illustrating the configuration of an apparatus for speech recognition according to another exemplary embodiment of the present invention. The configuration shown in FIG. 3 is another example of the apparatus for speech recognition shown in FIG. 1, and the components indicated by the same names and reference numerals such as the speech input unit 110, the offset waveform generating unit 120, the speech recognition waveform extracting unit 130, and the speech recognizing unit 140, perform the same functions and are operated by the controller of FIG. 1. Therefore, the same functions of the same components shown in FIG. 1 are not further described hereinbelow.

When a speech recognition operation initiates, an apparatus 100′ for speech recognition shown in FIG. 3 may be configured to determine whether an air conditioning system is operating, and when the air conditioning system is operating, the apparatus may be configured to operate an air conditioning controller 80 to output a control signal 02 to adjust the air volume and to thereby increase a rate of speech recognition. In particular, the air conditioning controller 80 may be configured to adjust the air volume from the air conditioning system 30 based on a control signal from the apparatus for speech recognition.

The air conditioning controller 80 may be configured to reduce the air volume from the air conditioning system 30 to a predetermined level or less in response to a signal showing the initiation of the speech recognition operation. Furthermore, the air conditioning controller 80 may be configured to reduce the values set in the driving unit which may generate noise in the speech recognition operation, such as the wind velocity and wind direction and the air volume from the air conditioning system 30. In particular, the control signal 02 for adjusting the air volume from the air conditioning system 30 may be output from the speech recognition waveform extracting unit 130 or the speech recognizing unit 140 of the apparatus 100′ for speech recognition, and a separate unit for adjusting the air volume from the air conditioning system 30 may be additionally included.

The operation flow in the apparatus for speech recognition having the configuration described above, according to an embodiment of the present invention, is described hereafter in more detail.

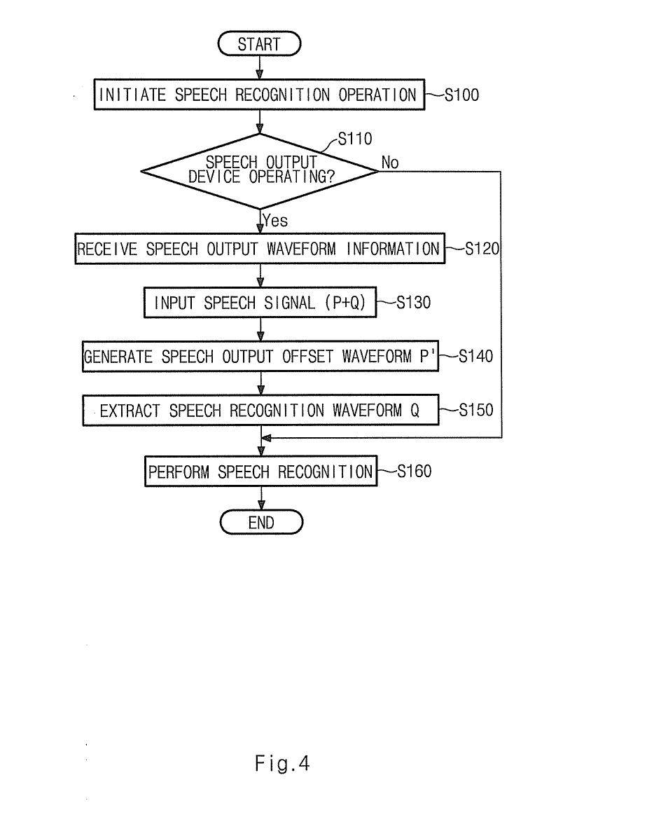

FIG. 4 is an exemplary flowchart illustrating the flow of operation of a method for speech recognition according to an exemplary embodiment of the present invention. Referring to FIG. 4, a controller may determine whether the speech output device is operating (S110), when the speech recognition operation initiates (S100). When the speech output device is operating, the information on a speech output waveform output through the speech output device may be received by the controller (S120).

Further, when a speech signal P+Q within the vehicle is input through a microphone or the like (S 130), the controller may be configured to generate a speech output offset waveform P′ based on the speech output waveform information input in S120 (S140). Furthermore, the controller may be configured to remove the speech output waveform P in the speech signal P+Q by overlapping the speech output offset waveform P′ generated in S140 to the speech signal P+Q input in S130 and may extract the speech recognition waveform Q (S150). Therefore, the apparatus for speech recognition may be configured to perform speech recognition, using the speech recognition waveform extracted in S150 (S160).

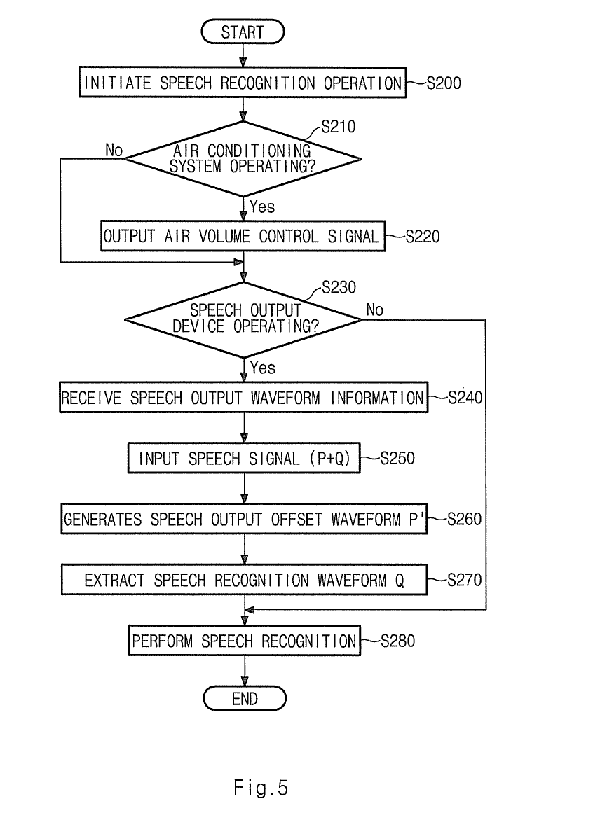

FIG. 5 is an exemplary flowchart illustrating the flow of operation of a method for speech recognition according to another exemplary embodiment of the present invention. Referring to FIG. 5, a controller may determine whether an air conditioning system is operating and may output a signal for adjusting the air volume (S210 and S220), when a speech recognition operation initiates (S200).

Thereafter, the controller may determine whether the speech output device is operating (S230), similar to that shown in FIG. 4, with the air volume from the air conditioning system adjusted. When the speech output device is determined to be operating, the information on a speech output waveform output through the speech output device may be received by the controller (S240).

Further, when a speech signal P+Q within the vehicle is input through a microphone or the like (S250), the controller may be configured to generate a speech output offset waveform P′ based on the speech output waveform information input in S240 (S260). The controller may be configured to remove the speech output waveform P in the speech signal P+Q by overlapping the speech output offset waveform P′ generated in S260 to the speech signal P+Q input in S250 and may extract the speech recognition waveform Q (S270). Therefore, the apparatus for speech recognition may be configured to perform speech recognition, using the speech recognition waveform extracted in S270 (S280).

According to the present invention, it may be possible to increase a rate of speech recognition by removing a speech output waveform from a speech signal with a speech output offset waveform generated by modulating the frequency feature of a speech output waveform output from a speech output device in speech recognition. Further, according to the present invention, it may be possible to increase a rate of speech recognition by reducing the air volume from an air conditioning system operated during speech recognition.

As described above, although an apparatus and a method for speech recognition according to the present invention were described with reference to the accompanying drawings, the present invention is not limited to the exemplary embodiments described herein and the accompanying drawings and may be modified within the protection range of the scope of the present invention.

What is claimed is:

1. An apparatus for speech recognition, comprising:
a controller configured to:
receive a speech signal including a speech recognition waveform from a user and a waveform of speech generated within a vehicle, when a speech recognition operation initiates;
generate an offset waveform corresponding to a speech output waveform generated from a speech output device within the vehicle, using feature information of the speech output waveform, when the speech recognition operation initiates;
extract the speech recognition waveform of the user by removing a predetermined amount or more of the speech output waveform from a speech signal, by overlapping the offset waveform to the speech signal; and
perform speech recognition based on the speech recognition waveform.

2. The apparatus according to claim 1, wherein the controller is further configured to:
generate an offset waveform corresponding to the speech output waveform based on the feature information of the speech output device generating the speech output waveform.

3. The apparatus according to claim 1, wherein the controller is further configured to:
generate an offset waveform corresponding to the speech output waveform by modulating the amplitude and the phase of the original signal based on the frequency feature of the speech output waveform.

4. The apparatus according to claim 1, wherein the offset waveform is a signal with the phase modulated by 180° from the speech output waveform.

5. The apparatus according to claim 1, wherein the controller is further configured to:
adjust the air volume from an air conditioning system by transmitting a signal indicating the initiation of a speech recognition operation to an air conditioning controller in a vehicle based on the waveforms in a speech signal, when the speech signal is input.

6. A method for speech recognition, comprising:
receiving, by a controller, a speech signal including a speech recognition waveform from a user and the waveform of speech generated within a vehicle, when a speech recognition operation initiates;
generating, by the controller, an offset waveform corresponding to a speech output waveform generated from a speech output device within the vehicle, using feature information of the speech output waveform, when the speech recognition operation initiates;
extracting, by the controller, the speech recognition waveform of the user by removing a predetermined amount or more of the speech output waveform from a speech signal, by overlapping the offset waveform to the speech signal; and
performing, by the controller, speech recognition based on the speech recognition waveform.

7. The method according to claim 6, wherein the generating of the offset waveform further comprises:
generating, by the controller, an offset waveform corresponding to the speech output waveform based on the feature information of the speech output device generating the speech output waveform.

8. The method according to claim 6, wherein the generating of the offset waveform further comprising:
generating, by the controller, an offset waveform corresponding to the speech output waveform by modulating the amplitude and the phase of the original signal based on the frequency feature of the speech output waveform.

9. The method according to claim 6, wherein the offset waveform is a signal with the phase modulated by 180° from the speech output waveform.

10. The method according to claim 6, further comprising:
adjusting, by the controller, the air volume from an air conditioning system by transmitting a signal indicating the initiation of a speech recognition operation to an air conditioning controller, when the speech recognition operation initiates.

11. A non-transitory computer readable medium containing program instructions executed by a controller, the computer readable medium comprising:
program instructions that receive a speech signal including a speech recognition waveform from a user and the waveform of speech generated within a vehicle, when a speech recognition operation initiates;
program instructions that generate an offset waveform corresponding to a speech output waveform generated from a speech output device within the vehicle, using feature information of the speech output waveform, when the speech recognition operation initiates;
program instructions that extract the speech recognition waveform of the user by removing a predetermined amount or more of the speech output waveform from a speech signal, by overlapping the offset waveform to the speech signal; and
program instructions that perform speech recognition based on the speech recognition waveform.

12. The non-transitory computer readable medium of claim 11, further comprising:
program instructions that generate an offset waveform corresponding to the speech output waveform based on the feature information of the speech output device generating the speech output waveform.

13. The non-transitory computer readable medium of claim 11, further comprising:
program instructions that generate an offset waveform corresponding to the speech output waveform by modulating the amplitude and the phase of the original signal based on the frequency feature of the speech output waveform.

14. The non-transitory computer readable medium of claim 11, wherein the offset waveform is a signal with the phase modulated by 180° from the speech output waveform.

15. The non-transitory computer readable medium of claim 11, further comprising:
program instructions that adjust the air volume from an air conditioning system by transmitting a signal indicating the beginning of a speech recognition operation to an air conditioning controller, when the speech recognition operation initiates.
